(19) United States
(12) Patent Application Publication
(10) Pub. No.: US 2023/0013031 A1
(43) Pub. Date: Jan. 19, 2023

(54) DISPLAY METHOD AND DISPLAY CONTROL APPARATUS

(71) Applicant: HUAWEI TECHNOLOGIES CO., LTD., Shenzhen (CN)

(72) Inventors: Weicheng LUO, Shenzhen (CN); Shaorui GAO, Shenzhen (CN); Haitao WANG, Beijing (CN); Peng ZHANG, Shenzhen (CN); Jiang LI, Shenzhen (CN)

(21) Appl. No.: 17/947,427

(22) Filed: Sep. 19, 2022

Related U.S. Application Data
(63) Continuation of application No. PCT/CN2021/078944, filed on Mar. 3, 2021.

(30) Foreign Application Priority Data
Mar. 20, 2020 (CN) 202010203698.2

(51) Int. Cl. H04N 13/363; G09G 3/36; H04N 13/383; G09G 3/00; H04N 13/302; G02B 30/56

(52) U.S. Cl. CPC H04N 13/363; G09G 3/36; H04N 13/383; G09G 3/002; G09G 3/003; H04N 13/302; G02B 30/56; G09G 2354/00

(57) ABSTRACT

This application discloses a display method and a display control apparatus. The display system includes a projection screen, the projection screen includes a transparent substrate and a liquid crystal film covering the transparent substrate, and the liquid crystal film includes a plurality of liquid crystal cells. The display method includes: obtaining a to-be-displayed image; determining a target liquid crystal cell from the plurality of liquid crystal cells based on locations of pixels in the to-be-displayed image; setting a status of the target liquid crystal cell to a scattering state, and setting a status of a non-target liquid crystal cell to a transparent state, where the non-target liquid crystal cell is a liquid crystal cell in the plurality of liquid crystal cells other than the target liquid crystal cell; and displaying a projection image of the to-be-displayed image on the target liquid crystal cell.

### CROSS-REFERENCE TO RELATED APPLICATIONS

This application is a continuation of International Application No. PCT/CN2021/078944, filed on Mar. 3, 2021, which claims priority to Chinese Patent Application No. 202010203698.2, filed on Mar. 20, 2020. The disclosures of the aforementioned applications are hereby incorporated by reference in their entireties.

### TECHNICAL FIELD

This application relates to the display field, and in particular, to a display method and a display control apparatus.

### BACKGROUND

When an image is displayed, two-dimensional display is used in a conventional method. With development of display technologies, replacing the two-dimensional display with three-dimensional display can bring better visual experience to users. Currently, when the user views, with naked eyes, an image displayed in three dimensions, a problem that a three-dimensional sense of the displayed three-dimensional image is not strong generally exists. Therefore, how to improve three-dimensional effect of viewing the three-dimensional image with naked eyes by the user becomes a technical problem to be urgently resolved.

### SUMMARY

This application provides a display method and a display control apparatus, to help improve three-dimensional effect of viewing a three-dimensional image with naked eyes by a user.

To achieve the objective, this application provides the following technical solutions.

According to a first aspect, this application provides a display method. The display method is applied to a terminal device, and the terminal device includes a projection screen. The projection screen includes a transparent substrate and a liquid crystal film covering the transparent substrate, and the liquid crystal film includes a plurality of liquid crystal cells. The display method includes: obtaining a to-be-displayed image; determining a target liquid crystal cell from the plurality of liquid crystal cells based on locations of pixels in the to-be-displayed image; setting a status of the target liquid crystal cell to a scattering state, and setting a status of a non-target liquid crystal cell to a transparent state, where the non-target liquid crystal cell is a liquid crystal cell in the plurality of liquid crystal cells other than the target liquid crystal cell; and then displaying a projection image of the to-be-displayed image on the target liquid crystal cell. Herein, a to-be-projected image of the to-be-displayed image may be projected on the target liquid crystal cell, so that the projection image of the to-be-displayed image is displayed on the target liquid crystal cell.

According to the foregoing method, the projection image of the to-be-displayed image is displayed on a transparent projection screen. Therefore, a background of the projection image of the to-be-displayed image is fused with an ambient environment, thereby improving a visual effect.

With reference to the first aspect, in a possible design manner, the “obtaining a to-be-displayed image” includes: selecting the to-be-displayed image from a stored image library, or downloading the to-be-displayed image from a network.

With reference to the first aspect, in another possible design manner, the to-be-displayed image includes a three-dimensional image, and the projection image of the to-be-displayed image includes a two-dimensional image. In this way, a two-dimensional projection image of a to-be-displayed three-dimensional image may be displayed on the transparent projection screen. When the two-dimensional projection image of the to-be-displayed three-dimensional image is viewed on a curved or three-dimensional projection screen with naked eyes, a realistic three-dimensional image that is “floating” in the air may be seen. Therefore, three-dimensional effect of viewing a three-dimensional image with naked eyes by a user is improved.

With reference to the first aspect, in another possible design manner, the “setting a status of the target liquid crystal cell to a scattering state, and setting a status of a non-target liquid crystal cell to a transparent state” includes:

setting a first preset voltage for the target liquid crystal cell to control the status of the target liquid crystal cell to be the scattering state; and setting a second preset voltage for the non-target liquid crystal cell to control the status of the non-target liquid crystal cell to be the transparent state; or setting a second preset voltage for the target liquid crystal cell to control the status of the target liquid crystal cell to be the scattering state; and setting a first preset voltage for the non-target liquid crystal cell to control the status of the non-target liquid crystal cell to be the transparent state.

The first preset voltage is greater than or equal to a preset value, and the second preset voltage is less than the preset value.

In this possible design manner, the projection image of the to-be-displayed image may be displayed on the transparent projection screen, so that the background of the projection image of the to-be-displayed image is fused with the ambient environment, thereby improving the visual effect.

With reference to the first aspect, in another possible design manner, the liquid crystal film includes a polymer dispersed liquid crystal film, a bistable liquid crystal film, or a dye-doped liquid crystal film.

With reference to the first aspect, in another possible design manner, the projection screen includes a curved screen, or the projection screen includes a three-dimensional screen. The curved screen or the three-dimensional screen is used, so that when viewing the two-dimensional projection image of the to-be-displayed three-dimensional image on the projection screen with naked eyes, the user can see the realistic three-dimensional image that is “floating” in the air. Therefore, the three-dimensional effect of viewing the three-dimensional image with naked eyes by the user is improved.

With reference to the first aspect, in another possible design manner, the display method further includes: tracking locations of human eyes. The “determining a target liquid crystal cell from the plurality of liquid crystal cells based on locations of pixels in the to-be-displayed image” includes: determining a location of the target liquid crystal cell in the plurality of liquid crystal cells based on the tracked locations of human eyes and the locations of the pixels in the to-be-displayed image. When the to-be-displayed image is the three-dimensional image, the location of the target liquid crystal cell used to display the projection image of the to-be-displayed image is determined based on the tracked locations of human eyes, so that a three-dimensional sense of viewing the projection image of the to-be-displayed image at the locations of human eyes can be improved.

With reference to the first aspect, in another possible design manner, if the to-be-displayed image is the three-dimensional image, the “determining a location of the target liquid crystal cell in the plurality of liquid crystal cells based on the tracked locations of human eyes and the locations of the pixels in the to-be-displayed image” includes: determining, in the plurality of liquid crystal cells based on an intersection point obtained by intersecting a connection line between the tracked locations of human eyes and a location of each pixel in the to-be-displayed image with the projection screen, a liquid crystal cell at the intersection point as the target liquid crystal cell.

With reference to the first aspect, in another possible design manner, the terminal device further includes a first projection lens, and the “projecting a to-be-projected image of the to-be-displayed image on the target liquid crystal cell” includes: adjusting a projection region of the first projection lens, so that the first projection lens projects the to-be-projected image in the target liquid crystal cell, where a field of view of the first projection lens is less than or equal to a preset threshold. In this way, when the to-be-displayed image is the three-dimensional image, a projection lens with a relatively small field of view is used, so that the to-be-projected image of the to-be-displayed image can still be projected on the target liquid crystal cell determined based on the locations of human eyes, thereby improving the three-dimensional sense of viewing the projection image of the to-be-displayed image at the locations of human eyes.

With reference to the first aspect, in another possible design manner, the terminal device further includes a second projection lens, and the “projecting a to-be-projected image of the to-be-displayed image on the target liquid crystal cell” includes: projecting the to-be-projected image of the to-be-displayed image on the target liquid crystal cell by using the second projection lens, where a field of view of the second projection lens is greater than a preset threshold.

With reference to the first aspect, in another possible design manner, the terminal device further includes an image source module, and the image source module is configured to project the to-be-projected image of the to-be-displayed image on the projection screen.

With reference to the first aspect, in another possible design manner, the tracking module may be disposed inside the terminal device, or may be disposed outside the terminal device. When the tracking module is disposed inside the terminal device, a volume of the terminal device can be reduced. When the tracking module is disposed outside the terminal device, because a detection light ray of the tracking module does not intersect the projection screen, an area used to display the projection image of the to-be-displayed image on the projection screen is increased. In this way, the projection image can be viewed at all tracked locations of human eyes in a larger range.

According to a second aspect, this application provides a display control apparatus. The apparatus is used in a terminal device, and the apparatus may be configured to perform any method provided in the first aspect. In this application, the display control apparatus may be divided into functional modules according to any method provided in the first aspect. For example, each functional module may be divided based on each corresponding function. In addition, two or more functions may be integrated into one processing module. For example, in this application, the display control apparatus may be divided into an obtaining unit, a determining unit, a setting unit, a control unit, and the like based on functions. For descriptions of possible technical solutions performed by the foregoing functional modules obtained through division and beneficial effects achieved by the foregoing functional modules, refer to the technical solutions provided in the first aspect or corresponding possible designs of the first aspect. Details are not described herein again.

According to a third aspect, this application provides a terminal device. The terminal device includes a projection screen, a processor, and the like. The terminal device may be configured to perform any method provided in the first aspect. For descriptions of possible technical solutions performed by each module component in the terminal device and beneficial effects achieved by the module component, refer to the technical solutions provided in the first aspect or corresponding possible designs of the first aspect. Details are not described herein again.

According to a fourth aspect, this application provides a chip system, including a processor. The processor is configured to invoke, from a memory, a computer program stored in the memory, and run the computer program, to perform any method provided in the implementations of the first aspect.

According to a fifth aspect, this application provides a computer-readable storage medium, for example, a non-transitory computer-readable storage medium. The computer-readable storage medium stores a computer program (or instruction). When the computer program (or instruction) is run on a computer, the computer is enabled to perform any method provided in any one of the possible implementations of the first aspect.

According to a sixth aspect, this application provides a computer program product. When the computer program product runs on a computer, any method provided in any one of the possible implementations of the first aspect is performed.

It may be understood that any one of the apparatus, the computer storage medium, the computer program product, the chip system, or the like provided above may be applied to a corresponding method provided above. Therefore, for beneficial effects that can be achieved by the apparatus, the computer storage medium, the computer program product, the chip system, or the like, refer to the beneficial effects of the corresponding method. Details are not described herein again.

In this application, names of the terminal device and the display control apparatus do not constitute any limitation to devices or functional modules. In actual implementation, the devices or functional modules may appear in other names Each device or functional module falls within the scope defined by the claims and their equivalent technologies in this application, provided that a function of the device or functional module is similar to that described in this application.

These aspects or other aspects in this application are more concise and comprehensible in the following descriptions.

### BRIEF DESCRIPTION OF DRAWINGS

FIG. 1 is a schematic diagram of a projection region according to an embodiment of this application;

FIG. 2 is a schematic diagram of a structure of a display system according to an embodiment of this application;

FIG. 3 is a schematic diagram of a structure of a liquid crystal film according to an embodiment of this application;

FIG. 4 is a schematic diagram of a structure of a projection screen according to an embodiment of this application;

FIG. 5A is a schematic diagram 1 of a hardware structure of a display system according to an embodiment of this application;

FIG. 5B is a schematic diagram 2 of a hardware structure of a display system according to an embodiment of this application;

FIG. 6A and FIG. 6B are a schematic flowchart of a display method according to an embodiment of this application;

FIG. 7 is a schematic diagram 1 of a display method according to an embodiment of this application;

FIG. 8 is a schematic diagram 2 of a display method according to an embodiment of this application;

FIG. 9 is a schematic diagram 3 of a display method according to an embodiment of this application;

FIG. 10 is a schematic diagram of a structure of a display control apparatus according to an embodiment of this application;

FIG. 11 is a schematic diagram of a structure of a chip system according to an embodiment of this application; and

FIG. 12 is a schematic diagram of a structure of a computer program product according to an embodiment of this application.

### DESCRIPTION OF EMBODIMENTS

The following describes some terms or technologies in embodiments of this application:

### (1) Motion Parallax

A retina can accept only stimulation of two-dimensional space, and reflection of three-dimensional space mainly depends on binocular vision. An ability of humans to perceive the world and determine a distance of an object in three dimensions through binocular vision is referred to as depth perception (depth perception). The depth perception is a comprehensive feeling, and is obtained by comprehensively processing, by using a brain, a plurality of types of information obtained by human eyes. Generally, information used to provide depth perception is referred to as a depth cue (depth cue). There is a complete depth cue in the real world.

Generally speaking, a “three-dimensional sense” of a three-dimensional display technology is related to whether an observer's depth perception of displayed content is close to the real world. Therefore, the “three-dimensional sense” of the three-dimensional display technology depends on whether the display technology can provide an appropriate depth cue in application of the display technology. A current three-dimensional display technology may generally provide one or more depth cues. For example, the depth cue may be a parallax, a shade-shadow relationship, or an overlapping relationship.

The parallax (parallax) refers to a location change and a location difference of a same object in sight when the object is observed from two different locations. When a target is viewed from two observation points, an angle between two lines of sight is referred to as a parallax angle of the two points, and a distance between the two points is referred to as a parallax baseline. The parallax may include binocular parallax and the motion parallax.

The binocular parallax refers to a horizontal difference that is between object images on retinas of left and right eyes and that is caused due to a difference between a normal pupil distance and a gaze angle. When a three-dimensional object is observed, a distance between the two eyes is about 60 mm. Therefore, the two eyes observe the three-dimensional object from different angles. The small horizontal differences in the retinal images due to a distance between the two eyes are referred to as binocular parallax (binocular parallax) or stereoscopic parallax.

The motion parallax, also referred to as “monocular motion parallax”, is one of monocular depth cues, and refers to differences in movement directions and speeds of objects seen when lines of sight move horizontally in sight. In relative displacement, a near object seems to move fast, and a far object seems to move slowly.

It should be noted that when an observer is close to an observed target, a binocular parallax is obvious. When the observer is far away from the observed object, for example, greater than 1 m, the binocular parallax may be ignored, and a motion parallax plays a dominant role.

### (2) To-be-Projected Two-Dimensional Projection Image and Two-Dimensional Projection Image

The to-be-projected two-dimensional projection image (equivalent to a to-be-projected image in embodiments of this application) is a two-dimensional projection image (equivalent to a projection image in embodiments of this application) obtained after coordinate conversion is performed on a to-be-displayed three-dimensional image (equivalent to a to-be-displayed image in embodiments of this application). The two-dimensional projection image may be displayed on a projection image source module 211 described below.

The two-dimensional projection image (equivalent to the projection image in embodiments of this application) is an image obtained by projecting the to-be-projected two-dimensional projection image onto a projection screen (for example, a projection screen 212 described below).

### (3) Projection Region

A projection lens has a specific range of projection region when projected on the projection screen. The projection region may be used to display the two-dimensional projection image.

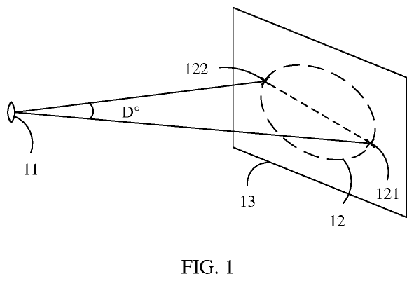

For example, refer to FIG. 1. As shown in FIG. 1, a projection region of a projection lens 11 on a projection screen 13 is a projection region 12 shown by a dashed ellipse, and a shape of the projection region 12 is related to an aperture shape of an aperture stop disposed on the projection lens 11. Herein, an angle between lines of separately connecting a point 121 and a point 122 that are farthest from each other in the projection region to the projection lens are referred to as a field of view (field of view, FOV). Herein, the FOV is D°.

### (4) Other Terms

In embodiments of this application, the word “example” or “for example” is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a relative concept in a specific manner.

In the descriptions of embodiments this application, unless otherwise stated, “I” means “or”. For example, A/B may represent A or B. A term “and/or” in this specification describes only an association relationship between associated objects and represents that there may be three relationships. For example, A and/or B may represent the following three cases: Only A exists, both A and B exist, and only B exists. In addition, in the descriptions of this application, unless otherwise stated, “a plurality of” means two or more than two.

An embodiment of this application provides a display method, and the method is applied to a display system. The method can provide an appropriate motion parallax. For a two-dimensional projection image displayed on a projection screen, a user may obtain information about the two-dimensional projection image with naked eyes, and may obtain viewing experience of a three-dimensional image through brain comprehensive processing with reference to the motion parallax.

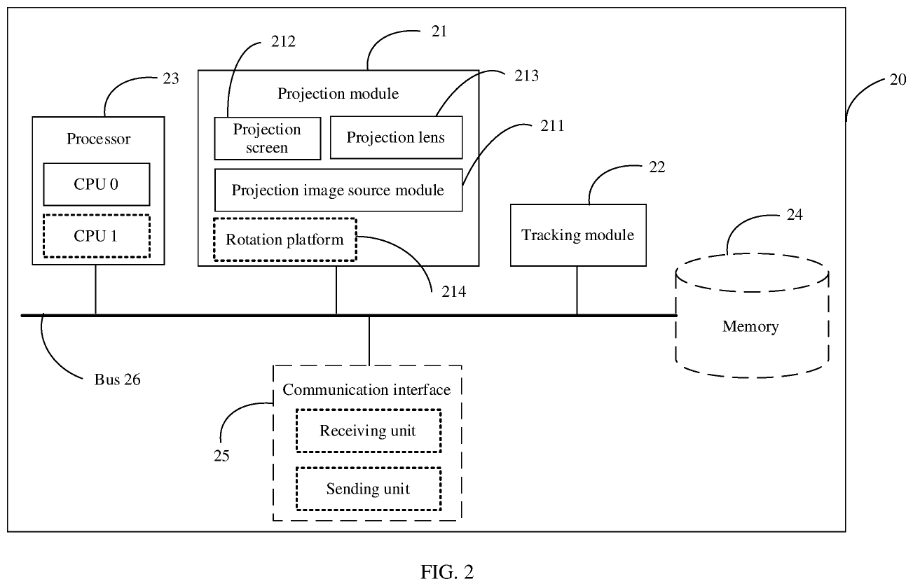

FIG. 2 is a schematic diagram of a structure of a display system according to an embodiment of this application. A display system 20 shown in FIG. 2 may include a projection module 21, a tracking module 22, and a processor 23.

Optionally, the display system 20 may further include a memory 24 and a communication interface 25. At least two modules/components of the projection module 21, the tracking module 22, the processor 23, the memory 24, and the communication interface 25 may be integrated into one device, or may be separately disposed on different devices.

An example in which the projection module 21, the tracking module 22, the processor 23, the memory 24, and the communication interface 25 are integrated into one terminal device is used. The display system 20 further includes a bus 26. The projection module 21, the tracking module 22, the processor 23, the memory 24, and the communication interface 25 may be connected through the bus 26. In this case, the terminal device may be any electronic device with a projection screen. This is not limited in this embodiment of this application. For example, the electronic device may be a smart speaker device with a projection screen.

The projection module 21 includes a projection image source module 211, a projection screen 212, and a projection lens 213.

The projection image source module 211 is configured to display a to-be-projected two-dimensional projection image, and project the to-be-projected two-dimensional projection image onto the projection screen 212 by using the projection lens 213. The projection image source module 211 includes a light source and an optical modulation element. Specific forms of the light source and the optical modulation element are not limited in this embodiment of this application. For example, the light source may be a light emitting diode (light emitting diode, LED) or laser, and the optical modulation element may be a digital light processing (digital light processing, DLP) system or a liquid crystal on silicon (liquid crystal on silicon, LCOS). The optical modulation element displays the to-be-projected two-dimensional projection image. Light emitted by the light source is modulated by the optical modulation element, to form the to-be-projected two-dimensional projection image. The to-be-projected two-dimensional projection image is projected onto the projection screen 212 by using the projection lens 213.

The projection screen 212 is configured to display the two-dimensional projection image. The projection screen 212 may be a curved screen or a three-dimensional screen. Certainly, the projection screen 212 may alternatively be a planar screen. Herein, the three-dimensional screen may be in a plurality of shapes, for example, a spherical shape, a cylindrical shape, a prismatic shape, a cone shape, or a polyhedron shape. This is not limited in this embodiment of this application.

The projection screen 212 includes a transparent substrate and a liquid crystal film covering the transparent substrate. A material of the transparent substrate is not limited in this embodiment of this application. For example, the transparent substrate may be a transparent glass substrate, or may be a transparent resin substrate. The liquid crystal film may be a polymer dispersed liquid crystal (polymer dispersed liquid crystal, PDLC) film, a bistable liquid crystal (bistable liquid crystal, BLC) film, a dye-doped liquid crystal (dye-doped liquid crystal, DDLC) film, or the like.

Specifically, the liquid crystal film includes a plurality of liquid crystal cells, and each liquid crystal cell has a scattering state and a transparent state. In addition, the processor 23 may control a status of each liquid crystal cell by using an electrical signal. Herein, relative to the transparent state, the scattering state may also be referred to as a non-transparent state. Each liquid crystal cell may correspond to one pixel in the two-dimensional projection image, or may correspond to a plurality of pixels in the two-dimensional projection image. Certainly, the plurality of liquid crystal cells may alternatively correspond to one pixel in the two-dimensional projection image. This is not limited in this embodiment of this application. It should be noted that a liquid crystal cell in the scattering state is configured to display the two-dimensional projection image.

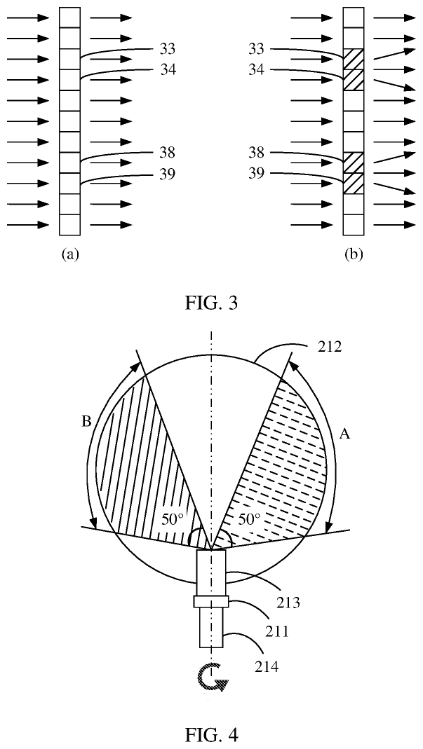

An example in which the liquid crystal film is the PDLC film is used for description. (a) in FIG. 3 shows a plurality of liquid crystal cells (each grid indicates one liquid crystal cell) in a PDLC film, a first preset voltage is set for each of the plurality of liquid crystal cells, and the first preset voltage is greater than or equal to a preset value. In this case, liquid crystal molecules of each of the plurality of liquid crystal cells are uniformly arranged along a direction of an electric field, so that incident light is emitted along an original direction after passing through the liquid crystal cell. Therefore, a status of the liquid crystal cell is the transparent state. If external voltages of a liquid crystal cell 33, a liquid crystal cell 34, a liquid crystal cell 38, and a liquid crystal cell 39 shown in (a) in FIG. 3 are set to a second preset voltage, where the second preset voltage is less than the preset value, liquid crystal molecules in the liquid crystal cell 33, the liquid crystal cell 34, the liquid crystal cell 38, and the liquid crystal cell 39 are arranged in a random direction. In this case, after incident light passes through the liquid crystal cell 33, the liquid crystal cell 34, the liquid crystal cell 38, and the liquid crystal cell 39, emergent light is scattered light, as shown in (b) in FIG. 3. In this case, the liquid crystal cell 33, the liquid crystal cell 34, the liquid crystal cell 38, and the liquid crystal cell 39 are in the scattering state, namely, the non-transparent state. The preset value of the voltage may be determined based on a specific component of the liquid crystal film and a proportion of each component. This is not limited in this embodiment of this application.

It should be noted that, if the liquid crystal film is the BLC film, when the first preset voltage is set for a liquid crystal cell in the BLC film, a status of the liquid crystal cell is the scattering state; or when the second preset voltage is set for the liquid crystal cell, the status of the liquid crystal cell is the transparent state. When the liquid crystal film is the dye-doped liquid crystal film, it may be set that: when the first preset voltage is set for a liquid crystal cell, a status of the liquid crystal cell is the scattering state, or when the second preset voltage is set for the liquid crystal cell, the status of the liquid crystal cell is the transparent state; or it may be set that: when the first preset voltage is set for a liquid crystal cell, a status of the liquid crystal cell is the transparent state, or when the second preset voltage is set for the liquid crystal cell, the status of the liquid crystal cell is the scattering state. This is not limited in this embodiment of this application.

The projection lens 213 is configured to project the to-be-projected two-dimensional projection image displayed in the projection image source module 211 onto the projection screen 212. The projection lens 213 may be a lens with a large field of view (field of view, FOV), for example, a fisheye lens with an FOV greater than 150° (equivalent to a second projection lens in embodiments of this application). Certainly, the projection lens 213 may alternatively be a projection lens with an FOV of about 40° to 70° (equivalent to a first projection lens in embodiments of this application). Herein, a field of view of the first projection lens is less than or equal to a preset threshold, and a field of view of the second projection lens is greater than the preset threshold. A value of the preset threshold is not limited in this embodiment of this application.

If the projection lens 213 is the first projection lens, the projection module 21 may further include a rotation platform 214. The rotation platform 214 is configured to adjust a projection region of the projection lens 213 by rotating an angle. A controller of the rotation platform 214 is connected to the processor 23, or a controller configured to control rotation of the rotation platform 214 is the processor 23.

For example, if the projection screen 212 is the three-dimensional screen, the projection lens 213 may be completely disposed inside the three-dimensional screen, or the projection lens 213 may be partially disposed inside the three-dimensional screen.

For example, if the projection screen 212 is a pillar-shaped projection screen such as the cylindrical projection screen or a square columnar projection screen, the projection lens 213 may implement a projection function by using an annular projection optical system. In this case, for the pillar-shaped projection screen, upper and lower surfaces of the pillar-shaped projection screen may not participate in projection display, and a side wall of the pillar-shaped projection screen may be used to display the two-dimensional projection image, which is certainly not limited thereto.

For example, as shown in FIG. 4. FIG. 4 shows a structural diagram of the projection module 21. An FOV of the projection lens 213 is 50°. The projection screen 212 is a spherical three-dimensional screen, and the projection lens 213 is partially disposed inside the projection screen 212. The projection lens 213 is located between the projection image source module 211 and the projection screen 212, and locations of the projection lens 213 and the projection image source module 211 are relatively fixed. The rotation platform 214 is configured to adjust the projection region of the projection lens 213. For example, at a current moment, a projection region of the projection lens 213 is A, and at a next moment, the processor 23 indicates the rotation platform 214 to rotate by X°, so that a projection region of the projection lens 213 is B shown in FIG. 4. Herein, a specific value of X is determined by the processor 23. For a specific process of determining the specific value of X by the processor 23, refer to the following descriptions of the display method in the embodiments of this application. Details are not described herein again.

The tracking module 22 is configured to track locations of human eyes, and send the tracked locations of human eyes to the processor 23. Specifically, the tracking module may track the locations of human eyes by using an infrared imaging technology. Certainly, this embodiment of this application is not limited thereto.

The processor 23 is a control center of the display system 20. The processor 23 may be a general-purpose central processing unit (central processing unit, CPU), another general-purpose processor, or the like. The general-purpose processor may be a microprocessor, any conventional processor, or the like. In an example, the processor 23 may include one or more CPUs, for example, a CPU 0 and a CPU 1 that are shown in FIG. 2.

Specifically, the processor 23 is configured to determine, based on locations of pixels in a to-be-displayed three-dimensional image and the locations of human eyes, a to-be-projected two-dimensional projection image of the to-be-displayed three-dimensional image, and send the two-dimensional projection image to the projection image source module 211. The processor 23 is further configured to: determine a location of a target liquid crystal cell on the projection screen 212 based on the locations of the pixels in the to-be-displayed three-dimensional image and the locations of human eyes; and control, by using a control circuit, a status of the target liquid crystal cell to be the scattering state and a status of a non-target liquid crystal cell to be the transparent state. Herein, the non-target liquid crystal cell is a liquid crystal cell in the projection screen 212 other than the target liquid crystal cell. The control circuit may be integrated into the liquid crystal film. This is not limited in this embodiment of this application.

The memory 24 may be a read-only memory (read-only memory, ROM) or another type of static storage device capable of storing static information and instructions, a random access memory (random access memory, RAM) or another type of dynamic storage device capable of storing information and instructions, an electrically erasable programmable read-only memory (electrically erasable programmable read-only memory, EEPROM), a magnetic disk storage medium or another magnetic storage device, or any other medium capable of carrying or storing expected program code in a form of an instruction or data structure and capable of being accessed by a computer, but is not limited thereto.

In a possible implementation, the memory 24 may be independent of the processor 23. The memory 24 may be connected to the processor 23 through the bus 26, and is configured to store data, instructions, or program code. When invoking and executing the instructions or the program code stored in the memory 24, the processor 23 can implement the display method provided in embodiments of this application.

In another possible implementation, the memory 24 may alternatively be integrated with the processor 23.

The communication interface 25 is configured to connect the display system 20 to another device (such as a server) by using a communication network. The communication network may be the Ethernet, a radio access network (radio access network, RAN), a wireless local area network (wireless local area network, WLAN), or the like. The communication interface 25 may include a receiving unit configured to receive data and a sending unit configured to send data.

The bus 26 may be an industry standard architecture (Industry Standard Architecture, ISA) bus, a peripheral component interconnect (Peripheral Component Interconnect, PCI) bus, an extended industry standard architecture (Extended Industry Standard Architecture, EISA) bus, or the like. The bus may be classified into an address bus, a data bus, a control bus, and the like. For ease of denotation, the bus is denoted by using only one bold line in FIG. 2. However, this does not indicate that there is only one bus or only one type of bus.

It should be noted that the structure shown in FIG. 2 does not constitute a limitation on the display system. In addition to the components shown in FIG. 2, the display system 20 may include more or fewer components than those shown in the figure, or combine some components, or have different component arrangements.

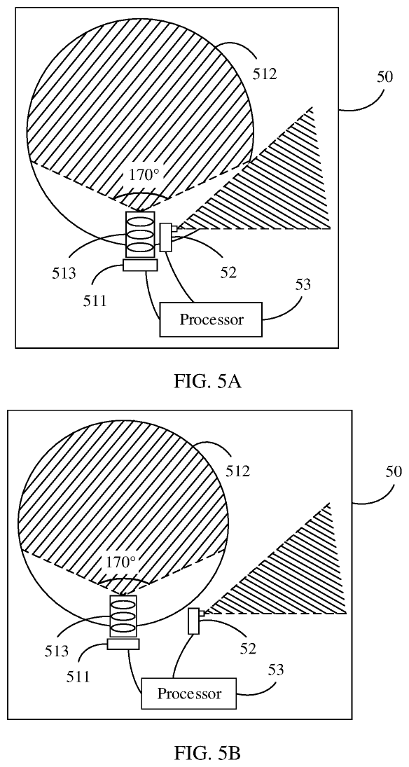

In an example, refer to FIG. 5A. FIG. 5A shows a hardware structure of a display system of a terminal device (for example, a smart speaker device) according to an embodiment of this application. A smart speaker device 50 includes a projection module, a tracking module, and a processor 53. The projection module includes a projection image source module 511, a projection screen 512, and a fisheye lens 513 whose FOV is 170°. The tracking module includes a tracking lens 52. In addition, the projection image source module 511 and the tracking lens 52 are separately connected to and communicate with the processor 53 through buses.

As shown in FIG. 5A, the projection screen 512 is a spherical projection screen. The projection screen 512 includes a spherical transparent substrate and a liquid crystal film covering the spherical transparent substrate. The liquid crystal film may cover an inner surface of the spherical transparent substrate, or may cover an outer surface of the spherical transparent substrate. In this embodiment of this application, an example in which the liquid crystal film covers the inner surface of the spherical transparent substrate is used for description. A shadow region corresponding to the fisheye lens 513 is a projectable region of the fisheye lens, and a shadow region corresponding to the tracking lens 52 is a range in which the tracking lens can track human eyes. It may be understood that the smart speaker device 50 may include a plurality of tracking lenses to track locations of human eyes within a 360° range.

The smart speaker device 50 may further include a voice collector and a voice player (which are not shown in FIG. 5A), and the voice collector and the voice player are separately connected to and communicate with the processor through buses. The voice collector is configured to collect a voice instruction of a user, and the voice player is configured to output voice information to the user. Optionally, the smart speaker device 50 may further include a memory (not shown in FIG. 5A). The memory is connected to and communicates with the processor, and is configured to store local data.

Certainly, the tracking lens 52 may alternatively be located outside the projection screen 512, as shown in FIG. 5B. This is not limited in this embodiment of this application. It may be understood that, if the tracking lens 52 is inside the projection screen 512, a volume of the smart speaker device 50 may be reduced. If the tracking lens 52 is outside the projection screen 512, a conflict between a display region of the projection screen and a tracking optical path of the tracking lens can be avoided, thereby obtaining a larger projection display region.

The following describes the display method in embodiments of the present invention with reference to accompanying drawing. In embodiments of this application, an example in which the display method is applied to the smart speaker device 50 shown in FIG. 5A is used for description.

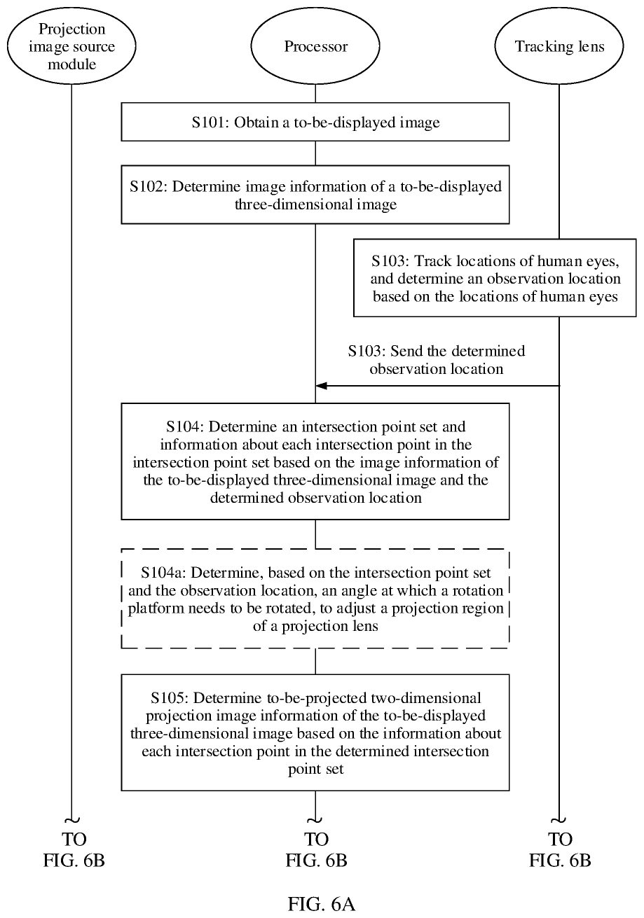

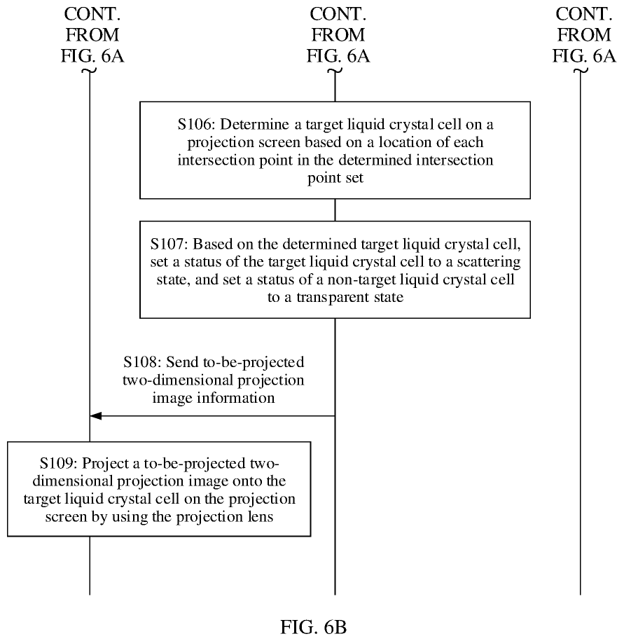

FIG. 6A and FIG. 6B are a schematic flowchart of a display method according to an embodiment of this application. The display method includes the following steps.

S101: A processor obtains a to-be-displayed image.

The to-be-displayed image may be a multi-dimensional image, for example, a three-dimensional image. In the following descriptions, an example in which the to-be-displayed image is a to-be-displayed three-dimensional image is used for description.

Specifically, the processor may obtain the to-be-displayed three-dimensional image from a network or a local image library based on obtained indication information. This is not limited in this embodiment of this application.

Specific content and a form of the indication information are not limited in this embodiment of this application. For example, the indication information may be indication information entered by a user by using a voice, a text, or a key, or the indication information may be trigger information detected by the processor, for example, power-on or power-off of a smart speaker device 50.

In a possible implementation, if the indication information is voice information entered by the user, the processor may obtain voice information collected by the smart speaker device by using a voice collector.

Content of the voice information may be a wakeup word of the smart speaker device, for example, “Xiao e Xiao e”. In this case, the processor invokes a three-dimensional image cartoon character of “Xiao e” from the local image library, and the three-dimensional image cartoon character is a to-be-displayed three-dimensional image.

Alternatively, content of the voice information may be any question raised by the user after the user speaks a wakeup word, for example, “help me search for a satellite map of this city”. In this case, the processor searches the network for and downloads a three-dimensional satellite map of this city, and the three-dimensional satellite map is a to-be-displayed three-dimensional image. For another example, the content of the voice information is “watching an XX movie”. In this case, the processor searches the network for and downloads the XX movie of a 3D version, where a current frame of the XX movie of the 3D version that is to be played is a to-be-displayed three-dimensional image at a current moment.

In another possible implementation, the indication information is non-voice information entered by the user, in other words, the user may enter the indication information by using a key or a touchscreen of the smart speaker device, or in any other manner in which the indication information can be entered. This is not limited in this embodiment of this application. Correspondingly, the processor may obtain the indication information entered by the user, and obtain the to-be-displayed three-dimensional image according to indication of the indication information.

In still another possible implementation, if the indication information is the trigger information detected by the processor, for example, the processor detects a power-on operation of the smart speaker device 50, the power-on operation triggers processing to obtain a three-dimensional image corresponding to the power-on operation, and the three-dimensional image is determined as a to-be-displayed three-dimensional image. For example, the three-dimensional image corresponding to the power-on operation may be a three-dimensional image indicating that a cartoon image character of the smart speaker device 50 beckons.

S102: The processor determines image information of the to-be-displayed three-dimensional image.

Specifically, the processor determines the image information of the to-be-displayed three-dimensional image in a preset three-dimensional coordinate system.

The image information of the to-be-displayed three-dimensional image is used to describe the to-be-displayed three-dimensional image. The to-be-displayed three-dimensional image may include a plurality of pixels. For each pixel in the plurality of pixels, the image information of the to-be-displayed three-dimensional image may be a coordinate location of the pixel in the preset three-dimensional coordinate system, color information and brightness information of the to-be-displayed three-dimensional image at the coordinate location, and the like.

The preset three-dimensional coordinate system is preset by the processor. For example, the preset three-dimensional coordinate system may be a three-dimensional coordinate system using a sphere center of a spherical projection screen as an origin. Certainly, the preset three-dimensional coordinate system may alternatively be a three-dimensional coordinate system using any point as an origin. This is not limited in this embodiment of this application. For ease of description, in the following embodiments of this application, an example in which the origin of the preset three-dimensional coordinate system is the sphere center of the spherical projection screen is used for description.

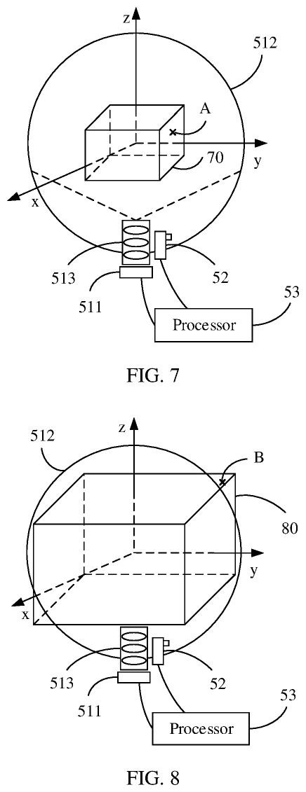

For example, with reference to FIG. 5A, refer to FIG. 7. As shown in FIG. 7, if the to-be-displayed three-dimensional image is a cuboid 70, any pixel A in a plurality of pixels that form the cuboid 70 may be represented by coordinates (xₐ, yₐ, zₐ). Herein, the coordinates (xₐ, yₐ, zₐ) are coordinate values in a three-dimensional coordinate system using a sphere center of the spherical projection screen 512 as an origin.

In addition, if a size of the to-be-displayed three-dimensional image is relatively large, locations of some pixels of the to-be-displayed three-dimensional image may be located outside the projection screen 512, so that pixels on a two-dimensional projection image corresponding to the some pixels are not displayed on the projection screen 512. With reference to FIG. 5A, refer to FIG. 8. Because a size of a cuboid 80 shown in FIG. 8 is excessively large, when the cuboid 80 is placed in the preset three-dimensional coordinate system, locations of some pixels are located outside the projection screen, for example, a point B in FIG. 8.

Optionally, to avoid the case shown in FIG. 8, the processor may reduce the size of the to-be-displayed three-dimensional image, so that a pixel in the two-dimensional projection image corresponding to each pixel in the to-be-displayed three-dimensional image can be displayed on the projection screen. Specifically, the processor may perform the following steps.

Step 1: The processor determines, in the preset three-dimensional coordinate system, a location of each pixel in the to-be-displayed three-dimensional image.

Step 2: The processor determines whether all pixels in the to-be-displayed three-dimensional image are located on a same side of the projection screen.

Specifically, the processor determines a distance between each pixel in the to-be-displayed three-dimensional image and an origin of coordinates based on a location of each pixel in the to-be-displayed three-dimensional image in the preset three-dimensional coordinate system. Then, the processor determines whether the distance between each pixel in the to-be-displayed three-dimensional image and the origin of coordinates is less than or equal to the radius of the projection screen 512. If the distance between each pixel in the to-be-displayed three-dimensional image and the origin of coordinates is less than or equal to the radius of the projection screen 512, the processor determines that the location of each pixel in the to-be-displayed three-dimensional image is located on the spherical projection screen 512, in other words, the to-be-displayed three-dimensional image is located on the same side of the projection screen 512. If a distance between at least one pixel in the to-be-displayed three-dimensional image and the origin of coordinates is greater than the radius of the projection screen 512, the processor determines that a pixel located outside the spherical projection screen 512 exists in the to-be-displayed three-dimensional image, in other words, the to-be-displayed three-dimensional image is located on the two sides of the projection screen 512.

Step 3: The processor zooms out (for example, zooms out according to a preset proportion) the to-be-displayed three-dimensional image, and repeatedly performs step 1 and step 2 until the processor determines that all the pixels in the zoomed-out to-be-displayed three-dimensional image are located on the same side of the projection screen. A specific value of the preset proportion and a manner of setting the value are not limited in this embodiment of this application.

S103: A tracking lens tracks locations of human eyes, determines an observation location based on the locations of human eyes, and sends the determined observation location to the processor. Alternatively, a tracking lens tracks locations of human eyes, and sends the tracked locations of human eyes to the processor, so that the processor determines an observation location based on the locations of human eyes.

The observation location is a single-point location determined based on locations of human eyes. A relationship between the observation location and the locations of human eyes is not limited in this embodiment of this application. For example, the observation location may be a midpoint of a line connecting the locations of human eyes.

The tracking lens presets a location of the tracking lens in the preset three-dimensional coordinate system. Both the location of the tracking lens in the preset three-dimensional coordinate system and the observation location may be represented by using coordinates in the preset three-dimensional coordinate system.

In an implementation, a tracking module includes the tracking lens and a calculation module. The tracking lens may track the locations of human eyes by using an infrared imaging technology based on the location of the tracking lens in the preset three-dimensional coordinate system. Then, the calculation module calculates the midpoint of the line connecting the locations of human eyes based on the locations of human eyes tracked by the tracking lens, uses a location of the calculated midpoint as an observation location, and sends the observation location to the processor. For a specific process in which the tracking lens tracks the locations of human eyes by using the infrared imaging technology, refer to the conventional technology. Details are not described herein.

For example, if the tracking lens tracks that a location of the left eye in the human eyes is E1 (xₑ₁, yₑ₁, zₑ₁), and a location of the right eye is E2 (xₑ₂, yₑ₂, zₑ₂), the calculation module calculates, based on the locations of E1 and E2, a location E (xₑ, yₑ, zₑ) of a midpoint of a connection line between E1 and E2, and sends the location E to the processor as an observation location.

In another implementation, a tracking module includes the tracking lens. The tracking lens may track, based on the location of the tracking lens in the preset three-dimensional coordinate system, the locations of human eyes by using an infrared imaging technology, and send the locations of human eyes to the processor. Then, the processor determines the observation location based on the received locations of human eyes. For example, the processor may calculate a location of the midpoint of the line connecting the locations of human eyes, and determine the location of the midpoint as the observation location.

It should be noted that a time sequence of performing S102 and S103 is not limited in this embodiment of this application. For example, S102 and S103 may be simultaneously performed, or S102 may be performed before S103.

S104: The processor determines an intersection point set and information about each intersection point in the intersection point set based on the image information of the to-be-displayed three-dimensional image and the determined observation location.

Specifically, the processor determines the intersection point set and the information about each intersection point in the intersection point set based on the determined observation location and the location of each pixel in the to-be-displayed three-dimensional image in the preset three-dimensional coordinate system.

The intersection point set includes a plurality of intersection points, and the plurality of intersection points are a plurality of intersection points that are obtained by separately intersecting a plurality of connection lines obtained by separately connecting the observation location to a plurality of pixels in the to-be-displayed three-dimensional image with the projection screen. For any pixel in the plurality of pixels, a connection line between the pixel and the observation location and the to-be-displayed three-dimensional image have no intersection point other than the pixel. In other words, the plurality of pixels are pixels included in a picture of the to-be-displayed three-dimensional image that can be viewed by human eyes at the observation location. In this way, for each pixel in the plurality of pixels, there is a correspondence between the pixel and an intersection point obtained by intersecting a connection line obtained by connecting the pixel to the observation location with the projection screen.

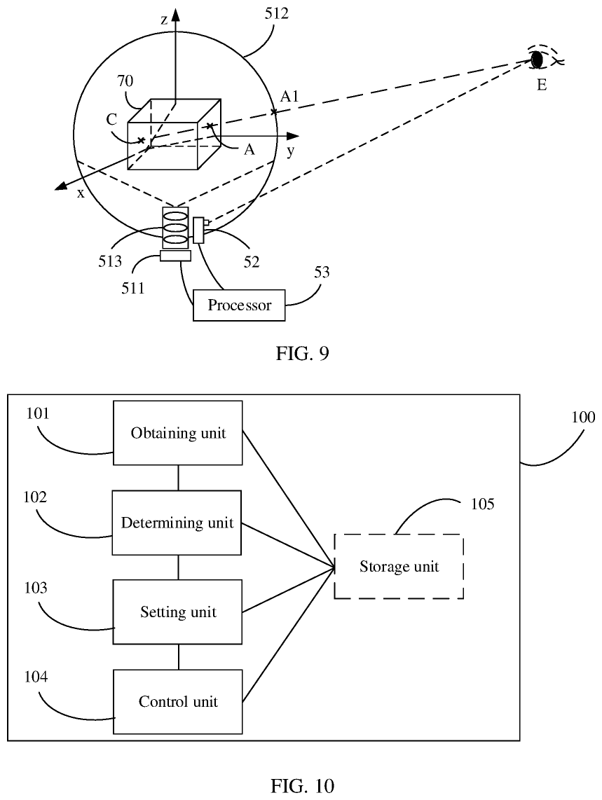

For example, with reference to FIG. 5A, refer to FIG. 9. FIG. 9 is a schematic diagram of determining any intersection point in the intersection point set by the processor. As shown in FIG. 9, a human eye shown by a dashed line represents the observation location E determined in step S103, and the cuboid 70 is a to-be-displayed three-dimensional image placed in the preset three-dimensional coordinate system. A connection line between any pixel A on the cuboid 70 and the observation location E is a connection line AE, the connection line AE and the projection screen 512 intersect at an intersection point A1 (xₐ₁, yₐ₁, zₐ₁), and there is no intersection point between the connection line AE and the cuboid 70 other than the pixel A. Therefore, there is a correspondence between the pixel A and the intersection point A1. A connection line between any pixel C on the cuboid 70 and the observation location E is a connection line CE, the connection line CE and the projection screen 512 intersect at the intersection point A1 (xₐ₁, yₐ₁, zₐ₁), and there is an intersection point between the connection line CE and the cuboid 70 other than the pixel C, namely, the pixel A. Therefore, there is no correspondence between the pixel C and the intersection point A1.

The intersection point A1 is any intersection point in the intersection point set. In addition, it can be learned from the foregoing description that the intersection point A1 may be a point on a liquid crystal film, or may be a point on the inner surface or the outer surface of the spherical transparent substrate in the projection screen.

It may be understood that, for a three-dimensional image, pictures of the three-dimensional image viewed by human eyes at different angles are different. Therefore, intersection point sets determined by the processor are different when observation locations are different.

For each intersection point in the determined intersection point set, information about the intersection point may include a location of the intersection point, color information and brightness information that correspond to the intersection point, and the like. The location of the intersection point is a location of the intersection point in the preset three-dimensional coordinate system. For example, a location of any intersection point in the intersection point set may be (xₛ, yₛ, zₛ). In addition, the color information and brightness information are color information and brightness information of a pixel that is in the to-be-displayed three-dimensional image and that has a correspondence with the intersection point.

It should be noted that the intersection point at which the connection line and the projection screen intersect may be an intersection point at which the connection line and the inner surface of the projection screen intersect, that is, the intersection point is a point on the liquid crystal film on the projection screen. Certainly, the intersection point at which the connection line and the projection screen intersect may alternatively be an intersection point at which the connection line and the outer surface of the projection screen (namely, the outer surface of the spherical transparent substrate in the projection screen) intersect, that is, the intersection point is a point on the outer surface of the spherical transparent substrate in the projection screen, or an intersection point at which the connection line and the inner surface of the spherical transparent substrate in the projection screen intersect, that is, the intersection point is a point on the inner surface of the spherical transparent substrate in the projection screen. This is not limited in this embodiment of this application.

S105: The processor determines to-be-projected two-dimensional projection image information of the to-be-displayed three-dimensional image based on the information about each intersection point in the determined intersection point set.

A two-dimensional projection image of the to-be-displayed three-dimensional image includes a plurality of pixels. For any one pixel in the pixels, two-dimensional projection image information of the to-be-displayed three-dimensional image includes a location of the pixel, color information and brightness information of the pixel, and the like. The location of the pixel may be determined based on a location of an intersection point in the intersection point set, and the color information and brightness information may be determined based on color information and brightness information of the intersection point in the intersection point set that is used to determine the location of the pixel.

The processor determines, based on a location of the intersection point in the intersection point set in the preset three-dimensional coordinate system, a two-dimensional location of a to-be-projected two-dimensional projection image when the to-be-projected two-dimensional projection image is displayed in a projection image source module, which may be determined with reference to a coordinate change method in the conventional technology and is not described in detail herein.

For example, the processor may preset locations of the projection image source module and a projection lens in the preset three-dimensional coordinate system, and a transmitting angle from the projection image source module to the projection lens during preset projection. The location of the projection image source module may be represented by coordinates of a center point of a display interface of the projection image source module in the preset three-dimensional coordinate system, and the location of the projection lens may be represented by coordinates of an intersection point between the projection lens and an optical axis of the projection lens in the preset three-dimensional coordinate system. Then, for each connection line in a plurality of connection lines obtained by connecting each intersection point in the intersection point set to the projection lens, the processor calculates an angle between the connection line and the optical axis of the projection lens, and obtains an emergent direction of the connection line relative to the projection lens based on the angle. Then, the processor determines, in the projection image source module based on the determined emergent direction, an optical attribute (for example, a focal length and a distortion attribute) of the projection lens, and the locations of the projection image source module and the projection lens in the preset three-dimensional coordinate system, a location of a pixel that is used to obtain a light ray in the emergent direction. That is, the processor transforms, according to the foregoing method, a location of an intersection point in the intersection point set in the preset three-dimensional coordinate system into a two-dimensional location of a to-be-projected two-dimensional projection image when the to-be-projected two-dimensional projection image is displayed in the projection image source module.

S106: The processor determines a target liquid crystal cell on the projection screen based on a location of each intersection point in the determined intersection point set.

Specifically, the processor determines a location of the target liquid crystal cell on the projection screen based on the location of each intersection point in the determined intersection point set. Herein, the target liquid crystal cell is configured to display a two-dimensional projection image. The location of the target liquid crystal cell is a two-dimensional coordinate location.

According to the descriptions in S104, if the intersection point in the intersection point set is a point on the liquid crystal film on the projection screen, x and y coordinates at a location of each intersection point in the intersection point set are the location of the target liquid crystal cell. If the intersection point in the intersection point set is on the outer surface or the inner surface of the spherical transparent substrate in the projection screen, the processor may determine the location of the target liquid crystal cell based on the location of each intersection point.

It may be understood that the liquid crystal film covers the transparent substrate of the projection screen. Therefore, points on the liquid crystal film one-to-one correspond to points on the transparent substrate. A distance between two points having a correspondence may be a thickness of the transparent substrate, or may be a sum of a thickness of the transparent substrate and a thickness of the liquid crystal film. This depends on whether the intersection point is a point on the outer surface or the inner surface of the spherical transparent substrate in the projection screen. If the intersection point is the point on the outer surface of the spherical transparent substrate in the projection screen, the distance between the two points having a correspondence is the sum of the thickness of the transparent substrate and the thickness of the liquid crystal film. If the intersection point is the point on the inner surface of the spherical transparent substrate in the projection screen, the distance between the two points having a correspondence is the thickness of the liquid crystal film.

Specifically, if the intersection point in the intersection point set is the point on the inner surface of the spherical transparent substrate in the projection screen, the processor determines coordinates of a location at which each intersection point in the intersection point set extends a distance of the thickness of the liquid crystal film towards one side of the liquid crystal film along a normal direction of the spherical transparent substrate at the point, and determines x and y coordinates of the location as the location of the target liquid crystal cell. Alternatively, if the intersection point in the intersection point set is the point on the outer surface of the spherical transparent substrate in the projection screen, the processor determines a location at which each intersection point in the intersection point set extends a distance of the sum of the thickness of the transparent substrate and the thickness of the liquid crystal film towards one side of the liquid crystal film along a normal direction of the spherical transparent substrate at the point, and determines x and y coordinates of the location as the location of the target liquid crystal cell.

S107: The processor sets, based on the determined target liquid crystal cell, a status of the target liquid crystal cell to a scattering state, and sets a status of a non-target liquid crystal cell to a transparent state.

The target liquid crystal cell in the scattering state may be configured to display the two-dimensional projection image of the to-be-displayed three-dimensional image.

Specifically, the processor may set the status of the target liquid crystal cell to the scattering state and set the status of the non-target liquid crystal cell to the transparent state in any one of the following manners:

Manner 1: The processor sends the location of the target liquid crystal cell to a control circuit. If the liquid crystal film in the projection screen is a PDLC film, the processor further indicates the control circuit to set a second preset voltage for the target liquid crystal cell, so that the target liquid crystal cell is in the scattering state; and indicates the control circuit to set a first preset voltage for the non-target liquid crystal cell, so that the non-target liquid crystal cell is in the transparent state.

If the liquid crystal film in the projection screen is a BLC film, the processor further indicates the control circuit to set a first preset voltage for the target liquid crystal cell, so that the target liquid crystal cell is in the scattering state; and indicates the control circuit to set a second preset voltage for the non-target liquid crystal cell, so that the non-target liquid crystal cell is in the transparent state.

If the liquid crystal film in the projection screen is a dye-doped liquid crystal film, the processor further indicates the control circuit to set a first preset voltage or a second preset voltage for one of the target liquid crystal cell and the non-target liquid crystal cell based on a preset correspondence between the first preset voltage or the second preset voltage and one of the scattering state and the transparent state, so that the target liquid crystal cell is in the scattering state and the non-target liquid crystal cell is in the transparent state. For example, the first preset voltage is set for the target liquid crystal cell, so that the target liquid crystal cell is in the scattering state; and the second preset voltage is set for the non-target liquid crystal cell, so that the non-target liquid crystal cell is in the transparent state. Alternatively, the second preset voltage is set for the target liquid crystal cell, so that the target liquid crystal cell is in the scattering state; and the first preset voltage is set for the non-target liquid crystal cell, so that the non-target liquid crystal cell is in the transparent state.

Manner 2: The processor compares a location of a liquid crystal cell in the scattering state (briefly referred to as a liquid crystal cell in the scattering state in this embodiment of this application) on the projection screen at a current moment with the location of the target liquid crystal cell. If there is an intersection between the location of the liquid crystal cell in the scattering state and the location of the target liquid crystal cell, the processor sends the location of the target liquid crystal cell outside the intersection to a control circuit.

If the liquid crystal film in the projection screen is a PDLC film, the processor further indicates the control circuit to set a second preset voltage for the target liquid crystal cell outside the intersection, so that the target liquid crystal cell outside the intersection is in the scattering state; and indicates the control circuit to set a first preset voltage for the non-target liquid crystal cell outside the intersection, so that the non-target liquid crystal cell outside the intersection is in the transparent state.

If the liquid crystal film in the projection screen is a BLC film, the processor further indicates the control circuit to set a first preset voltage for the target liquid crystal cell outside the intersection, so that the target liquid crystal cell outside the intersection is in the scattering state; and indicates the control circuit to set a second preset voltage for the non-target liquid crystal cell outside the intersection, so that the non-target liquid crystal cell outside the intersection is in the transparent state.

If the liquid crystal film in the projection screen is a dye-doped liquid crystal film, the processor indicates the control circuit to set a first preset voltage or a second preset voltage for one of the target liquid crystal cell outside the intersection and the non-target liquid crystal cell outside the intersection based on a preset correspondence between the first preset voltage or the second preset voltage and one of the scattering state and the transparent state, so that the target liquid crystal cell outside the intersection is in the scattering state and the non-target liquid crystal cell outside the intersection is in the transparent state. For example, the first preset voltage is set for the target liquid crystal cell outside the intersection, so that the target liquid crystal cell outside the intersection is in the scattering state; and the second preset voltage is set for the non-target liquid crystal cell outside the intersection, so that the non-target liquid crystal cell outside the intersection is in the transparent state. Alternatively, the second preset voltage is set for the target liquid crystal cell outside the intersection, so that the target liquid crystal cell outside the intersection is in the scattering state; and the first preset voltage is set for the non-target liquid crystal cell outside the intersection, so that the non-target liquid crystal cell outside the intersection is in the transparent state.

It should be noted that a time sequence of performing S105 and S106 and S107 is not limited in this embodiment of this application. For example, S105 and S106 and S107 may be simultaneously performed, or S105 may be performed before S106 and S107.

S108: The processor sends the to-be-projected two-dimensional projection image information to the projection image source module.

The processor sends the to-be-projected two-dimensional projection image information determined in S105 to the projection image source module.

In response to an operation of the processor, the projection image source module receives the to-be-projected two-dimensional projection image information, and displays, based on the to-be-projected two-dimensional projection image information, the to-be-projected two-dimensional projection image.

S109: The projection image source module projects, by using the projection lens, the to-be-projected the two-dimensional projection image onto the target liquid crystal cell on the projection screen.

Specifically, S109 may refer to the conventional technology to project the to-be-projected two-dimensional projection image onto the target liquid crystal cell on the projection screen, and details are not described herein again.

In the foregoing descriptions, the projection lens uses the fisheye lens 513 whose FOV is 170° for projection. If the projection lens whose FOV is about 40° to 70° is used for projection, the smart speaker device 50 shown in FIG. 5A further includes a rotation platform.

In this case, S104 further includes the following step.

S104a: The processor determines, based on the intersection point set and the observation location, an angle by which the rotation platform needs to rotate, to adjust a projection region of the projection lens.

Optionally, the processor may first determine a location of a center point of the intersection point set in a region in which the intersection point set is located on the projection screen. Then, the processor determines that an angle between a connection line between the center point and an observation point and a current optical axis of the projection lens is the angle by which the rotation platform needs to rotate. Then, the processor sends the angle value to a controller of the rotation platform, so that the rotation platform rotates by the angle. In this way, the connection line between the center point and the observation point may coincide with the optical axis of the projection lens. In other words, the projection region of the projection lens is adjusted to cover a region in which the intersection point set is located on the projection screen.

In response to an operation of the processor, the rotation platform rotates by the angle determined by the processor, so that the projection region of the projection lens may cover the region in which the intersection point set is located on the projection screen.

It should be noted that, because the target liquid crystal cell is determined based on the location of the intersection point in the intersection point set, the projection region needs to cover the region in which the intersection point set determined in S104 is located. In this way, the to-be-projected two-dimensional projection image can be projected by the projection lens to the target liquid crystal cell.

In conclusion, according to the display method provided in this embodiment of this application, the locations of human eyes are tracked by using a tracking technology, then the intersection point set of the to-be-displayed three-dimensional image and the projection screen is determined based on the locations of human eyes, and the two-dimensional projection image of the to-be-displayed three-dimensional image is further determined based on the intersection point set. Therefore, after the two-dimensional projection image of the to-be-displayed three-dimensional image is projected onto the target liquid crystal cell in the scattering state on the projection screen, realistic three-dimensional effect is achieved. In addition, the non-target liquid crystal cell on the projection screen is in the transparent state, in other words, a region in which the non-target liquid crystal cell is located on the projection screen is transparent. In other words, the two-dimensional projection image of the to-be-displayed three-dimensional image is displayed on the transparent projection screen. Therefore, a background of the two-dimensional projection image of the to-be-displayed three-dimensional image is fused with an ambient environment. When the user views the two-dimensional projection image of the to-be-displayed three-dimensional image on the projection screen with naked eyes, the user can see a realistic three-dimensional image that is “floating” in the air. Therefore, three-dimensional effect of viewing the three-dimensional image with naked eyes by the user is improved.

The foregoing mainly describes the solutions provided in embodiments of this application from the perspective of the methods. To implement the foregoing functions, corresponding hardware structures and/or software modules for performing the functions are included. A person skilled in the art should easily be aware that, in combination with units and algorithm steps of the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the display control apparatus may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example, and is merely logical function division. In actual implementation, another division manner may be used.

FIG. 10 is a schematic diagram of a structure of a display control apparatus 100 according to an embodiment of this application. The display control apparatus 100 may be used in a terminal device. The terminal device includes a projection screen. The projection screen includes a transparent substrate and a liquid crystal film covering the transparent substrate. The liquid crystal film includes a plurality of liquid crystal cells. The display control apparatus 100 may be configured to control display of a to-be-displayed image on the projection screen of the terminal device, and configured to perform the foregoing display method, for example, configured to perform the method shown in FIG. 6A and FIG. 6B. The display control apparatus 100 may include an obtaining unit 101, a determining unit 102, a setting unit 103, and a control unit 104.

The obtaining unit 101 is configured to obtain the to-be-displayed image. The determining unit 102 is configured to determine a target liquid crystal cell from the plurality of liquid crystal cells based on locations of pixels in the to-be-displayed image. The setting unit 103 is configured to set a status of the target liquid crystal cell to a scattering state, and set a status of a non-target liquid crystal cell to a transparent state, where the non-target liquid crystal cell is a liquid crystal cell in the plurality of liquid crystal cells other than the target liquid crystal cell. The control unit 104 is configured to control a projection image of the to-be-displayed image to be displayed on the target liquid crystal cell. For example, refer to FIG. 6A and FIG. 6B. The obtaining unit 101 may be configured to perform S101, the determining unit 102 may be configured to perform S106, and the setting unit 103 may be configured to perform S107.

Optionally, the to-be-displayed image includes a three-dimensional image, and the projection image of the to-be-displayed image includes a two-dimensional image.

Optionally, the setting unit 103 is specifically configured to:

set a first preset voltage for the target liquid crystal cell to control the status of the target liquid crystal cell to be the scattering state; and set a second preset voltage for the non-target liquid crystal cell to control the status of the non-target liquid crystal cell to be the transparent state; or set a second preset voltage for the target liquid crystal cell to control the status of the target liquid crystal cell to be the scattering state; and set a first preset voltage for the non-target liquid crystal cell to control the status of the non-target liquid crystal cell to be the transparent state.

The first preset voltage is greater than or equal to a preset value, and the second preset voltage is less than the preset value.

For example, refer to FIG. 6A and FIG. 6B. The setting unit 103 may be configured to perform S107.

Optionally, the liquid crystal film includes a polymer dispersed liquid crystal film, a bistable liquid crystal film, or a dye-doped liquid crystal film.

Optionally, the projection screen includes a curved screen, or the projection screen includes a three-dimensional screen.

Optionally, the terminal device further includes a tracking module, and the tracking module is configured to track locations of human eyes. The determining unit 102 is further configured to: determine a location of the target liquid crystal cell in the plurality of liquid crystal cells based on the tracked locations of human eyes and the locations of the pixels in the to-be-displayed image. For example, refer to FIG. 6A and FIG. 6B. The determining unit 102 may be configured to perform S102 to S106.

Optionally, if the to-be-displayed image is the three-dimensional image, the determining unit 102 is specifically configured to: determine, in the plurality of liquid crystal cells based on an intersection point obtained by intersecting a connection line between the tracked locations of human eyes and a location of each pixel in the to-be-displayed image with the projection screen, a liquid crystal cell at the intersection point as the target liquid crystal cell. For example, refer to FIG. 6A and FIG. 6B. The determining unit 102 may be configured to perform S102 to S106.

Optionally, the terminal device further includes a rotation platform and a first projection lens. The control unit 104 is specifically configured to control the rotation platform to adjust a projection region of the first projection lens, so that the first projection lens projects a to-be-projected image in the target liquid crystal cell, and the projection image of the to-be-displayed image is displayed on the target liquid crystal cell, where a field of view of the first projection lens is less than or equal to a preset threshold. For example, refer to FIG. 6A and FIG. 6B. The control unit 104 may be configured to perform S104a.

Optionally, the terminal device further includes a second projection lens. The control unit 104 is specifically configured to control the second projection lens to project a to-be-projected image in the target liquid crystal cell, so that the projection image of the to-be-displayed image is displayed on the target liquid crystal cell, where a field of view of the second projection lens is greater than a preset threshold.

Certainly, the display control apparatus 100 provided in this embodiment of this application includes but is not limited to the foregoing units. For example, the display control apparatus 100 may further include a storage unit 105. The storage unit 105 may be configured to store program code of the display control apparatus 100 and the like.

For specific descriptions of the foregoing optional manners, refer to the foregoing method embodiments. Details are not described herein again. In addition, for any explanation of the display control apparatus 100 provided above and descriptions of beneficial effects, refer to the foregoing corresponding method embodiments. Details are not described herein again.

For example, with reference to FIG. 2, the obtaining unit 101 in the display control apparatus 100 may be implemented through the communication interface 25 in FIG. 2. Functions implemented by the determining unit 102, the setting unit 103, and the control unit 104 may be implemented by the processor 23 in FIG. 2 by executing program code in the memory 24 in FIG. 2. A function implemented by the storage unit 105 may be implemented by the memory 24 in FIG. 2.

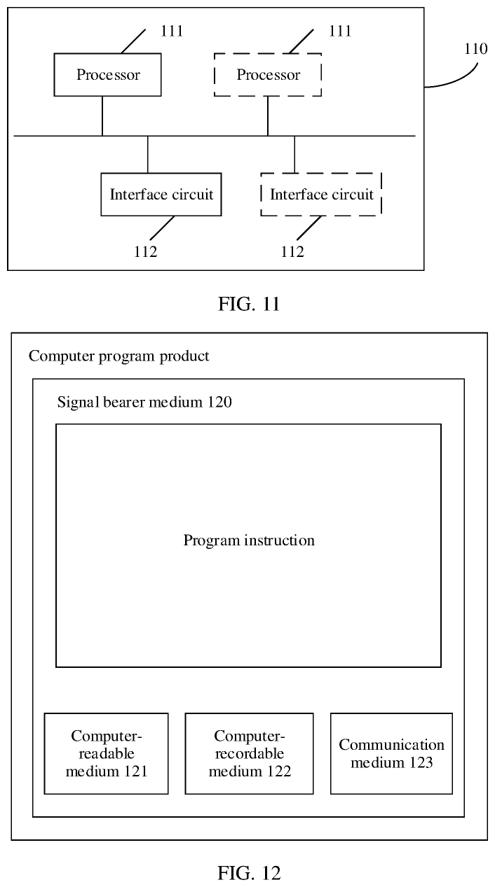

An embodiment of this application further provides a chip system 110. As shown in FIG. 11, the chip system 110 includes at least one processor 111 and at least one interface circuit 112. The processor 111 and the interface circuit 112 may be connected to each other through a line. For example, the interface circuit 112 may be configured to receive a signal (for example, receive a signal from a tracking module). For another example, the interface circuit 112 may be configured to send a signal to another apparatus (for example, the processor 111). For example, the interface circuit 112 may read instructions stored in a memory, and send the instructions to the processor 111. When the instructions are executed by the processor 111, the display control apparatus is enabled to perform the steps in the foregoing embodiments. Certainly, the chip system 110 may further include another discrete device. This is not specifically limited in this embodiment of this application.

Another embodiment of this application further provides a computer-readable storage medium. The computer-readable storage medium stores instructions. When the instructions are run on a display control apparatus, the display control apparatus performs the steps performed by the display control apparatus in the method procedure shown in the foregoing method embodiments.

In some embodiments, the disclosed method may be implemented as computer program instructions encoded in a machine-readable format on a computer-readable storage medium or encoded on another non-transitory medium or product.

FIG. 12 schematically shows a conceptual partial view of a computer program product according to an embodiment of this application. The computer program product includes a computer program used to execute a computer process on a computing device.

In an embodiment, the computer program product is provided by using a signal bearer medium 120. The signal bearer medium 120 may include one or more program instructions. When the one or more program instructions are run by one or more processors, the functions or some of the functions described in FIG. 6A and FIG. 6B may be provided. Therefore, for example, one or more features described with reference to S101 to S109 in FIG. 6A and FIG. 6B may be borne by one or more instructions associated with the signal bearer medium 120. In addition, the program instructions in FIG. 12 are also described as example instructions.

In some examples, the signal bearer medium 120 may include a computer-readable medium 121, for example, but is not limited to, a hard disk drive, a compact disk (CD), a digital video disc (DVD), a digital tape, a memory, a read-only memory (read-only memory, ROM), or a random access memory (random access memory, RAM).

In some implementations, the signal bearer medium 120 may include a computer-recordable medium 122, for example, but is not limited to, a memory, a read/write (R/W) CD, or an R/W DVD.

In some implementations, the signal bearer medium 120 may include a communication medium 123, for example, but is not limited to, a digital and/or analog communication medium (for example, an optical fiber, a waveguide, a wired communication link, or a wireless communication link).

The signal bearer medium 120 may be conveyed by the communication medium 123 in a wireless form (for example, a wireless communication medium that complies with the IEEE 802.11 standard or another transport protocol). The one or more program instructions may be, for example, one or more computer-executable instructions or one or more logic implementation instructions.

In some examples, the display control apparatus described with reference to FIG. 6A and FIG. 6B may be configured to provide various operations, functions, or actions in response to the one or more program instructions in the computer-readable medium 121, the computer-recordable medium 122, and/or the communication medium 123.

It should be understood that the arrangement described herein is merely used as an example. Thus, a person skilled in the art appreciates that another arrangement and another element (for example, a machine, an interface, a function, a sequence, and a group of functions) can be used to replace the arrangement, and some elements may be omitted together depending on a desired result. In addition, many of the described elements are functional entities that can be implemented as discrete or distributed components, or implemented in any suitable combination at any suitable location in combination with another component.

All or some of the foregoing embodiments may be implemented by using software, hardware, firmware, or any combination thereof. When a software program is used to implement embodiments, embodiments may be implemented partially in a form of a computer program product. The computer program product includes one or more computer instructions. When the computer-executable instructions are loaded and executed on a computer, the procedures or functions according to embodiments of this application are all or partially generated. The computer may be a general-purpose computer, a special-purpose computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state drive, SSD)), or the like.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A display method, wherein the display method is applied to a terminal device, the terminal device comprises a projection screen, the projection screen comprises a transparent substrate and a liquid crystal film covering the transparent substrate, and the liquid crystal film comprises a plurality of liquid crystal cells; and the method comprises:
obtaining a to-be-displayed image;
determining a target liquid crystal cell from the plurality of liquid crystal cells based on locations of pixels in the to-be-displayed image;
setting a status of the target liquid crystal cell to a scattering state, and setting a status of a non-target liquid crystal cell to a transparent state, wherein the non-target liquid crystal cell is a liquid crystal cell in the plurality of liquid crystal cells other than the target liquid crystal cell; and
displaying a projection image of the to-be-displayed image on the target liquid crystal cell.

2. The method according to claim 1, wherein the to-be-displayed image comprises a three-dimensional image, and the projection image of the to-be-displayed image comprises a two-dimensional image.

3. The method according to claim 1, wherein the setting a status of the target liquid crystal cell to a scattering state, and setting a status of a non-target liquid crystal cell to a transparent state comprises:
setting a first preset voltage for the target liquid crystal cell to control the status of the target liquid crystal cell to be the scattering state; and setting a second preset voltage for the non-target liquid crystal cell to control the status of the non-target liquid crystal cell to be the transparent state, wherein the first preset voltage is greater than or equal to a preset value, and the second preset voltage is less than the preset value; or
setting a second preset voltage for the target liquid crystal cell to control the status of the target liquid crystal cell to be the scattering state; and setting a first preset voltage for the non-target liquid crystal cell to control the status of the non-target liquid crystal cell to be the transparent state, wherein the first preset voltage is greater than or equal to a preset value, and the second preset voltage is less than the preset value.

4. The method according to claim 1, wherein the liquid crystal film comprises a polymer dispersed liquid crystal film, a bistable liquid crystal film, or a dye-doped liquid crystal film.

5. The method according to claim 1, wherein the projection screen comprises a curved screen, or the projection screen comprises a three-dimensional screen.

6. The method according to claim 1, wherein the method further comprises:
tracking locations of human eyes; and
the determining a target liquid crystal cell from the plurality of liquid crystal cells based on locations of pixels in the to-be-displayed image comprises:
determining a location of the target liquid crystal cell in the plurality of liquid crystal cells based on the tracked locations of human eyes and the locations of the pixels in the to-be-displayed image.

7. The method according to claim 6, wherein if the to-be-displayed image is the three-dimensional image, the determining a location of the target liquid crystal cell in the plurality of liquid crystal cells based on the tracked locations of human eyes and the locations of the pixels in the to-be-displayed image comprises:
determining, in the plurality of liquid crystal cells based on an intersection point obtained by intersecting a connection line between the tracked locations of human eyes and a location of each pixel in the to-be-displayed image with the projection screen, a liquid crystal cell at the intersection point as the target liquid crystal cell.

8. The method according to claim 1, wherein the terminal device further comprises a first projection lens, and the displaying a projection image of the to-be-displayed image on the target liquid crystal cell comprises:
adjusting a projection region of the first projection lens, so that the first projection lens projects a to-be-projected image of the to-be-displayed image in the target liquid crystal cell, and the projection image of the to-be-displayed image is displayed on the target liquid crystal cell, wherein a field of view of the first projection lens is less than or equal to a preset threshold.

9. The method according to claim 1, wherein the terminal device further comprises a second projection lens, and the displaying a projection image of the to-be-displayed image on the target liquid crystal cell comprises:
projecting a to-be-projected image of the to-be-displayed image in the target liquid crystal cell by using the second projection lens, so that the projection image of the to-be-displayed image is displayed on the target liquid crystal cell, wherein a field of view of the second projection lens is greater than a preset threshold.

10. A display control apparatus, wherein the apparatus is used in a terminal device, the terminal device comprises a projection screen, the projection screen comprises a transparent substrate and a liquid crystal film covering the transparent substrate, and the liquid crystal film comprises a plurality of liquid crystal cells; and the apparatus comprises:
an obtaining unit, configured to obtain a to-be-displayed image;
a determining unit, configured to determine a target liquid crystal cell from the plurality of liquid crystal cells based on locations of pixels in the to-be-displayed image;
a setting unit, configured to set a status of the target liquid crystal cell to a scattering state, and set a status of a non-target liquid crystal cell to a transparent state, wherein the non-target liquid crystal cell is a liquid crystal cell in the plurality of liquid crystal cells other than the target liquid crystal cell; and
a control unit, configured to control a projection image of the to-be-displayed image to be displayed on the target liquid crystal cell.

11. The apparatus according to claim 10, wherein the to-be-displayed image comprises a three-dimensional image, and the projection image of the to-be-displayed image comprises a two-dimensional image.

12. The apparatus according to claim 10, wherein the setting unit is further configured to:
set a first preset voltage for the target liquid crystal cell to control the status of the target liquid crystal cell to be the scattering state; and set a second preset voltage for the non-target liquid crystal cell to control the status of the non-target liquid crystal cell to be the transparent state, wherein the first preset voltage is greater than or equal to a preset value, and the second preset voltage is less than the preset value; or
set a second preset voltage for the target liquid crystal cell to control the status of the target liquid crystal cell to be the scattering state; and set a first preset voltage for the non-target liquid crystal cell to control the status of the non-target liquid crystal cell to be the transparent state, wherein the first preset voltage is greater than or equal to a preset value, and the second preset voltage is less than the preset value.

13. The apparatus according to claim 10, wherein the liquid crystal film comprises a polymer dispersed liquid crystal film, a bistable liquid crystal film, or a dye-doped liquid crystal film.

14. The apparatus according to claim 10, wherein the projection screen comprises a curved screen, or the projection screen comprises a three-dimensional screen.

15. The apparatus according to claim 10, wherein the terminal device further comprises a tracking module, and the tracking module is configured to track locations of human eyes; and
the determining unit is further configured to: determine a location of the target liquid crystal cell in the plurality of liquid crystal cells based on the tracked locations of human eyes and the locations of the pixels in the to-be-displayed image.

16. The apparatus according to claim 15, wherein if the to-be-displayed image is the three-dimensional image,
the determining unit is further configured to: determine, in the plurality of liquid crystal cells based on an intersection point obtained by intersecting a connection line between the tracked locations of human eyes and a location of each pixel in the to-be-displayed image with the projection screen, a liquid crystal cell at the intersection point as the target liquid crystal cell.

17. The apparatus according to claim 10, wherein the terminal device further comprises a rotation platform and a first projection lens; and
the control unit is further configured to control the rotation platform to adjust a projection region of the first projection lens, so that the first projection lens projects a to-be-projected image in the target liquid crystal cell, and the projection image of the to-be-displayed image is displayed on the target liquid crystal cell, wherein a field of view of the first projection lens is less than or equal to a preset threshold.

18. The apparatus according to claim 10, wherein the terminal device further comprises a second projection lens; and
the control unit is further configured to control the second projection lens to project a to-be-projected image in the target liquid crystal cell, so that the projection image of the to-be-displayed image is displayed on the target liquid crystal cell, wherein a field of view of the second projection lens is greater than a preset threshold.

19. A chip system, wherein the chip system comprises a processor, and the processor is configured to invoke, from a memory, a computer program stored in the memory, and run the computer program, so that the processor performs the method comprises:
obtaining a to-be-displayed image;
determining a target liquid crystal cell from the plurality of liquid crystal cells based on locations of pixels in the to-be-displayed image;
setting a status of the target liquid crystal cell to a scattering state, and setting a status of a non-target liquid crystal cell to a transparent state, wherein the non-target liquid crystal cell is a liquid crystal cell in the plurality of liquid crystal cells other than the target liquid crystal cell; and
displaying a projection image of the to-be-displayed image on the target liquid crystal cell.

20. A computer-readable storage medium, wherein the computer-readable storage medium stores a computer program; and when the computer program is run on a computer, the computer is enabled to perform the method comprises:
obtaining a to-be-displayed image;
determining a target liquid crystal cell from the plurality of liquid crystal cells based on locations of pixels in the to-be-displayed image;
setting a status of the target liquid crystal cell to a scattering state, and setting a status of a non-target liquid crystal cell to a transparent state, wherein the non-target liquid crystal cell is a liquid crystal cell in the plurality of liquid crystal cells other than the target liquid crystal cell; and
displaying a projection image of the to-be-displayed image on the target liquid crystal cell.
